(19) United States
(12) Patent Application Publication
(10) Pub. No.: US 2017/0132282 A1
(43) Pub. Date: May 11, 2017

(54) Virtual De-Normalization

(71) Applicant: Michael Wayne Martin, Ocean Isle Beach, NC (US)

(72) Inventor: Michael Wayne Martin, Ocean Isle Beach, NC (US)

(21) Appl. No.: 14/936,742

(22) Filed: Nov. 10, 2015

(51) Int. Cl. G06F 17/30

(52) U.S. Cl. CPC G06F 17/30466; G06F 17/30699

(57) ABSTRACT

This document discloses a software, data structure, method, apparatus and article of manufacture that allows database engines to implement tables that simultaneously exhibit the advantages of both normalization and de-normalization. Examples of such advantages include no data replication or minimum data replication, no table joins or a minimum number of joins, the ability to update data in one place and one place only, and query performance comparable to the same queries on heavily or fully de-normalized tables.

### REFERENCES CITED

### U.S. Patent Documents

U.S. Pat. No. 5,359,724 October, 1994 Earle 707/205.

U.S. Pat. No. 5,369,761 March 1990 Conley et al. 707/E17.007.

U.S. Pat. No. 5,864,857 January, 1999 Ohata et al. 707/100.

U.S. Pat. No. 5,940,818 August, 1999 Malloy et al. 707/2.

U.S. Pat. No. 5,943,668 August, 1999 Malloy et al. 707/3.

U.S. Pat. No. 6,003,036 December, 1999 Martin 707/102.

U.S. Pat. No. 6,134,541 October, 2000 Castelli et al. 707/2.

U.S. Pat. No. 6,182,060 January, 2001 Hedgcock et al. 707/1.

U.S. Pat. No. 6,460,026 October, 2002 Pasumansky 707/1.

U.S. Pat. No. 6,898,590 December, 2001 Streifer 707.999.002

U.S. Pat. No. 7,822,776 October, 2010 Martin 707/796.

U.S. Pat. No. 9,020,910 October,2010 Bendel et al. 707/693.

PCT/US2013/058491 September 2013 Idicula et al.

### Other References

Markl, V., et al., “Improving OLAP Performance by Multidimensional Hierarchical Clustering”, Proceedings of Ideas '99 in Montreal Canada, IEEE, 1999.

Markl, V., et al., “The Tetris-Algorithm for Multidimensional Sorted Reading from UB-Trees”, Internal Report, FORWISS Miinchen, 1997.

Bertino, E., et al., “Indexing Technique for Queries on Nested Objects”, IEEE Transactions on Knowledge and Data Engineering, pp. 196-214, 1989.

Inmon, Bill, “Building the Data Warehouse”, 1992.

Kimball, Ralph, Ross Margy, “The Data Warehouse Toolkit: The Complete Guide to Dimensional Modeling”, 2002.

Inmon, W. H., Denormalization of Data, SMC XII Proc. of 12th Structured Methods Conf., 6 Aug. 1987.

### BACKGROUND OF THE INVENTION

Technical Field

The present invention relates to OLAP (On-Line Analytical Processing) and DW (Data Warehouse) applications, hereafter referred to as the DW. Specifically, it relates to the design of structured or semi-structured database tables and underlying internal data structures in the database to support the DW in a flexible, performant, and efficient manner.

Description of Prior Art

DW applications have highlighted the need for fast and efficient methods to store, maintain, and query both large and complex data to support analytic applications.

One of the most important design decisions for any DW relates to the level of normalization in the design and structure of the database tables in the DW. This design decision forces trade offs between flexibility, storage space, agility, maintenance costs, update performance, and query speed. As a result, good DW designs need to balance these trade-offs, preventing optimal performance in any one area such as query speed. Despite the conventional need for a balanced approach, DW designs span a wide spectrum from completely de-normalized to fully normalized.

On one extreme, the approach is to fully de-normalize DW tables up to the point that the structure of each table contains a superset of the data required for each report or query to be extracted from the DW. This provides maximum query speed and ease of use for the specific use cases for which it was designed. However, the existence of a de-normalized table to match every query and report clearly increases storage requirements and the time to update the data. If normalized tables are completely replaced by de-normalized tables, this technique can also fail to preserve important business rules embedded in the data and its associated relationships. Less obviously, it reduces agility and the capability for the designers of the DW to adapt the database design for new data and new use cases. In some cases, too much normalization can even hamper query speed by increasing Input/Output (I/O) operations and processing time to filter out unneeded data.

On the other extreme, the approach is to fully normalize the DW design. This approach is close to the technique advocated by Bill Inmon, albeit Inmon does recognize the need for some de-normalizaton in addition to a foundation of normalized tables. This approach provides maximum flexibility, accurate preservation of business rules, agility, and update speed. It also minimizes storage costs. Its weakness, however, is query speed, query efficiency, and ease of use. Depending on underlying hardware and software such as Massively Parallel Processing (MPP) or in-memory technology, the approach can also provide acceptable query performance. But, even in this case the cost of underlying hardware is expensive and thus inefficient. This inefficiency is further magnified when a large number of users are attempting to run reports and queries simultaneously.

The dimensional design approach, made popular by Ralph Kimball, is a balance of the two extremes. This approach, minimizes redundant primary key to foreign key relationships between data elements, concentrates the source of primary keys for foreign key relationships in dimensions, and limits de-normalization to dimensions and aggregates of fact tables. In general, dimensional designs and aggregations are the preferred approach to balance between normalization and de-normalization for DW applications. When applied with expert knowledge and a good understanding of business requirements, this technique provides a good balance of query performance, agility, and update performance. Nonetheless, due to optimizer instability, overhead in software layers, and the ultimate unpredictability of analytic queries, this technique commonly exhibits problems with query performance and query efficiency. Furthermore, overuse of aggregates reduces agility. And, despite the natural ease of use associated with dimensional database designs, too much normalization can produce hard to use and overly complex dimensional designs with too much “snow flaking”.

A few attempts have been made to balance trade-offs between normalization and de-normalization with internal data structures and algorithms. While these techniques operate below the use interface or SQL level, they generally involve some type of data replication. A specific example is join or aggregate indexes. With join or aggregate indexes, the underlying data structures are automatically updated as the underlying tables are updated. When queries are run against the underlying tables, they are redirected to the join or aggregate indexes. This allows queries to execute in a performant and efficient manner. From an update perspective, data must still be replicated and maintained in multiple locations. Therefore, the net result of this technique is the same as classic de-normalization with most the same trade-offs. This technique simply automates the process.

A technique that allows the update efficiency, update performance, flexibility, business rule preservation, and agility of a normalized data model along with the query efficiency, query performance, and ease of use of a de-normalized data is indicated.

### SUMMARY OF OBJECTS AND ADVANTAGES

Objects and advantages that follow do not limit the scope of the present invention in any way. The claims alone should determine the scope of the present invention.

As the below embodiments detail, the present invention provides a method and apparatus that simultaneously provides all the advantages and efficiency of both normalized and de-normalized data.

One object and advantage of virtual de-normalization allows DW applications to query data without the need to join multiple tables together. This provides query performance and efficiency as well as ease of use.

A second object and advantage of virtual de-normalization allows normalized data objects to be accessed directly for update efficiency and full preservation of business rules. This provides less expensive maintenance of data and a more accurate representation of the business model that the data supports.

A third object and advantage of virtual de-normalization allows DW applications to be stored with minimum or no replication without sacrificing query performance, query efficiency, or ease of use.

An additional object and advantage of virtual de-normalization makes it immune to the instability of query optimizers in determining query execution paths for each query variation. Virtual de-normalization implements views of the data combining data from more than one normalized table as internal processes and data structures within the database engine where it can enforce more control, efficiency, and stability. The execution path for the single view of multiple tables is the same for all queries that access it, thus eliminating the need to create an optimizer plan for each query.

Another object and advantage of virtual de-normalization allows DW applications to practically perform update operations directly on de-normalized views of the data since interrelationships between the data elements can be efficiently controlled and maintained below the user interface or SQL layer of the database engine.

Yet another object and advantage of virtual de-normalization allows it to efficiently support NoSQL databases that implement the concept of virtual columns or attributes. This allows the same NoSQL table construct to support both normalized and de-normalized versions of the same data.

### BRIEF DESCRIPTION OF THE DRAWINGS

FIG. 1 illustrates a normalized product dimension with the two levels of Products and Categories.

FIG. 2 illustrates a normalized date dimension with the four levels of Weeks, Months, Quarters, and Years.

FIG. 3 illustrates a normalized fact table, Tool Sales, with foreign keys for the dimensions of Products and Weeks.

FIG. 4 illustrates a de-normalized fact table, Tool Sales, with the complete product and date dimensions included.

FIG. 5 illustrates a single computer with a hierarchy of storage mediums consisting of arrays of auxiliary memory, RAM, and processor caches capable of housing virtually de-normalized data. This architecture implements a shared memory parallel DW platform.

FIG. 6 illustrates an array of interconnected computers, containing hierarchies of storage mediums consisting of arrays of auxiliary memory, RAM, and processor caches capable of housing virtually de-normalized data. This architecture implements a no-share parallel DW platform.

### DETAILED DESCRIPTION OF THE INVENTION

Detailed descriptions, example embodiments, and drawing figures below do not limit the scope of the present invention in any way. The claims alone should determine the scope of the present invention.

### Overview

Virtual de-normalization allows database tables to be designed and implemented both as normalized and de-normalized schemas. The normalized schemas are physically stored and implemented. The de-normalized schemas are virtually stored and materialized dynamically when queries or updates are executed. Unlike classic database views, virtual de-normalization is implemented below the user interface or SQL level and need not depend on database optimizers or query implementation software to determine execution paths.

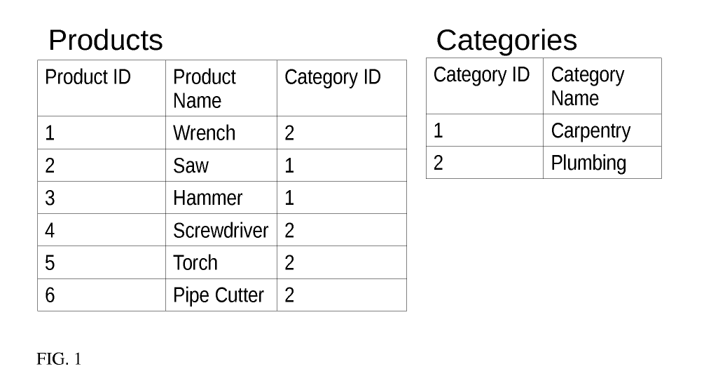

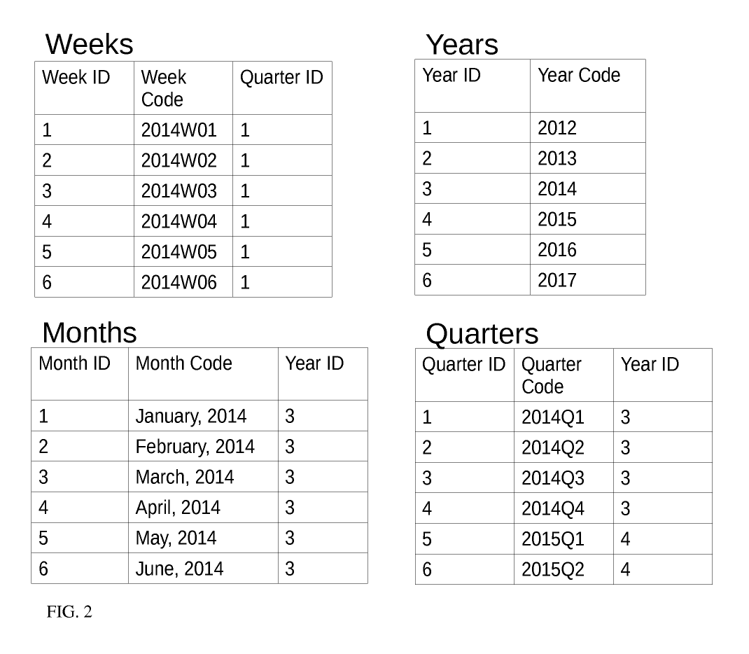

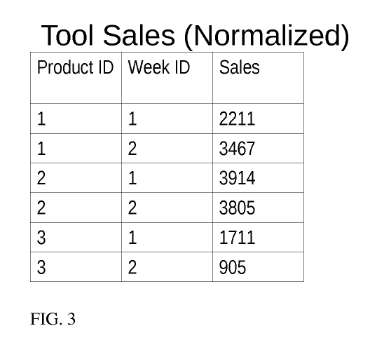

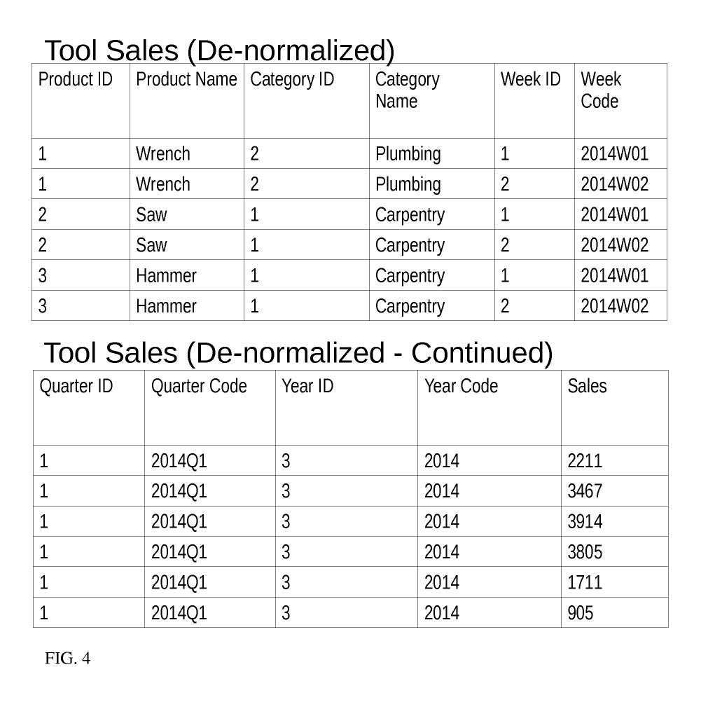

With virtual de-normalization, the DW designer creates the underlying normalized tables as represented by the examples in FIG. 1, FIG. 2, and FIG. 3. In addition to these tables, the DW designer also creates virtually de-normalized tables as represented by the example in FIG. 4. These virtual tables are logically very similar to views in classic relational databases. Whereas classic views are implemented at the user interface or SQL level and executed through the database optimizer, virtually de-normalized tables are implemented internally without the optimizer or query implementation software and therefore are much more performant and efficient. In this scenario, predetermined join paths and index strategies are implemented in the internals of the database to dynamically materialize the virtually de-normalized tables for queries and updates. Finally, this approach is also very stable and reliable since the optmizer or query implementation software does not determine them when a query is designed or executed. The execution strategy and paths are preset for all subsequent queries when the virtually de-normalized table is created, rather than created on a query by query basis.

### Operation

With virtual de-normalization, operations on underlying normalized tables are no different than conventional databases. Tables are queried and updated in a standard way through the user or SQL interface and executed via the optimizer. The operations on virtually de-normalized tables are slightly different.

When DW queries access virtually de-normalized tables, the database engine utilizes preset, internal data structures and algorithms to dynamically materialize the de-normalized view of the data by joining and optionally filtering one or more underlying normalized tables.

When DW updates execute against virtually de-normalized tables, the database engine utilizes internal join paths and indexes to redirect the update operations to the correct normalized tables. In addition to updating the underlying data via the virtually de-normalized tables, update operations can access the normalized tables directly.

### Example Embodiments

In one embodiment, designers of relational database engines can implement virtual de-normalization into conventional databases and DW systems to be accessed with standard SQL. Analytic queries can join normalized tables via the optimizer or could access virtually de-normalized database tables, thereby circumventing the database optimizer and materializing the tables via internal data structures and algorithms in a manner transparent to the queries. It is even possible to access a combination of the two types of tables, normalized and virtually de-normalized, in the same query.

In another embodiment, designers of NoSQL or key-value databases can implement virtual de-normalization so that NoSQL can more efficiently implement virtual columns. In this case, virtual de-normalization can perform joins and filters within the database to produce virtual column values on demand as if they are stored as a key-value pair in the NoSQL database.

In other embodiments, designers of DW applications can use virtually de-normalized tables to pre-join and support heavily normalized DW designs as advocated by Inmon or dimensional DW designs as advocated by Kimball.

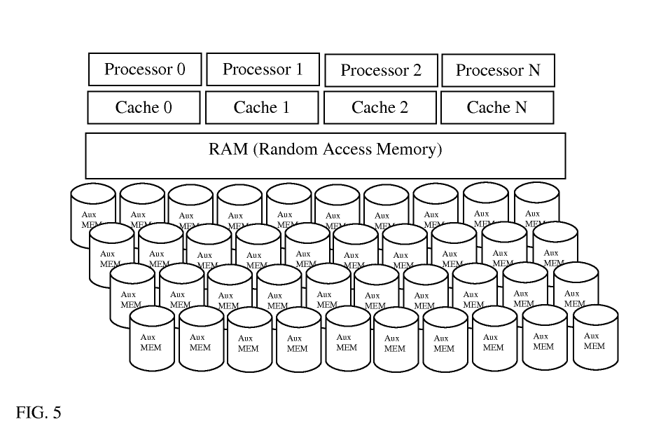

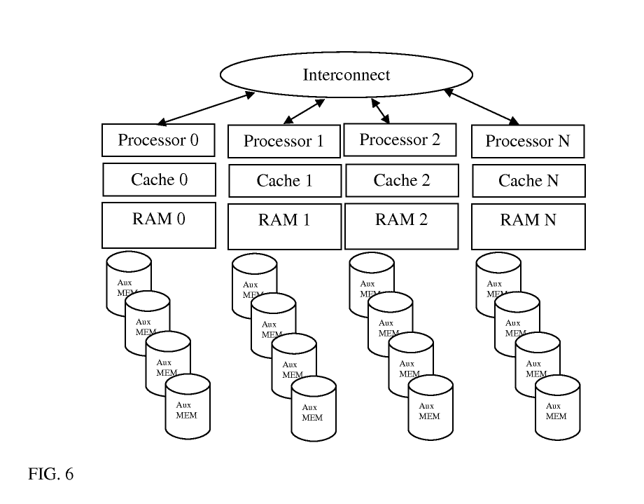

In yet other embodiments, virtually de-normalized DW applications are implemented and executed on small single user personal computers, highly parallel shared memory DW platforms as depicted in FIG. 5, or no-share parallel DW platforms as depicted in FIG. 6.

1-13. (canceled)

14. A method for presenting data from databases so that applications and users of the data can efficiently access multiple database tables as if they are one logical table without pre-joining or fully replicating the underlying data, the method comprising:
Storing the data in normalized or partially normalized tables, providing database interfaces with direct access to said normalized or partially normalized tables; providing virtually de-normalized tables derived from said normalized or partially normalized tables that dynamically join said normalized or partially normalized tables without data replication and with minimum data replication so that performance is as good or better than de-normalized tables; and making said virtually de-normalized tables appear to the optimizer or other query implementation software as de-normalized tables that have been pre-joined and optionally pre-aggregated.

15. The method of claim 14, wherein normalized or partially normalized dimensions are virtually joined to fact tables to present the detailed or aggregated data in a dimensional format containing facts and dimensions while still providing direct access to the underlying dimensions.

16. The method of claim 14, wherein normalized or partially normalized tables are virtually joined to present a semantic or application level view of the data while still providing direct access to the underlying normalized or partially normalized tables.

17. The method of claim 14, wherein normalized or partially normalized tables at a lower level of detail are virtually aggregated or accumulated into summary tables without actually computing and replicating the summary tables.

18. The method of claim 14, wherein custom filters for each user or session are used to limit or restrict said virtually de-nomalized tables.

19. The method of claim 14, wherein updates can be made to the virtually de-normalized tables and said method updates said normalized or partially normalized tables from which said virtually de-normalized tables are derived.

20. The method of claim 14, wherein said virtually de-normalized tables are implemented on one monolithic computer including processors, input/output devices, and memory.

21. The method of claim 14, wherein said virtually de-normalized tables are implemented on a network of interconnected computers so that said virtually de-normalized tables are derived from said normalized or partially denormalized tables existing on one or more interconnected computers.

22. The method of claim 21, wherein said virtually de-normalized tables are implemented on a network of parallel computers working in unison to provide access to said virtually de-normalzied tables.

23. The method of claim 14, wherein said virtually de-normalized tables are implemented within an application so that interfaces to said virtually de-normalized tables are controlled via said application.

24. The method of claim 14, where said virtually de-normalized tables are implemented on a hiearchical, network, or custom database management system.

25. The method of claim 14, wherein said virtually de-normalized tables are implemented on a relational database management system.

26. The method of claim 14, wherein said virtually de-normalized tables are implemented on a NoSQL or key-value database so that columns or attributes can be added or removed dynamically and implemented as schema on read.
